(19) United States
(12) Patent Application Publication
(10) Pub. No.: US 2004/0018130 A1
(43) Pub. Date: Jan. 29, 2004

(54) Method for wet stabilization of material or waste to reduce selenium leaching potential

(76) Inventor: Keith Edward Forrester, Meredith, NH (US)

Correspondence Address: KEITH EDWARD FORRESTER, 78 TRACY WAY, MEREDITH, NH, 03253, US

(21) Appl. No.: 10/200,624

(22) Filed: Jul. 23, 2002

(51) Int. Cl. B01D 11/02

(52) U.S. Cl. 422/261

(57) ABSTRACT

This invention provides a method for chemical stabilization of selenium bearing materials and wastes subject to acid and water leaching tests or leach conditions by addition of water and selenium stabilizing agents such that the leaching potential is inhibited to desired levels. The resultant material or waste after stabilization is deemed suitable for on-site reuse, off-site reuse or disposal as RCRA non-hazardous waste.

### BACKGROUND OF THE INVENTION

Over the past twenty years, the potential dangers of selenium bearing materials and waste has been the subject of community pressure, public awareness and ever stricter regulatory control in order to reduce or eliminate the dangers to people directly and to the surrounding environment. The leaching of selenium into groundwater is a grave concern because of the danger that the drinking water supplies and the environment will become contaminated. The leaching of selenium from most soil and wastes would result from solution into rainwater or surface waters . . . not necessarily from leaching from a solid waste landfill leaching environment as waste regulations in United States consider.

Selenium bearing materials and wastes, including ash and scrubber residues from brick furnace ash air pollution control devices such as cyclones, electrostatic precipitators and baghouse filter bags, may be deemed hazardous by the United States Environmental Protection Agency (U.S. EPA) pursuant to 40 C.F.R. Part 261 if containing Se. Any solid waste can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity as tested under the TCLP leaching procedure.

40 C.F.R., Part 261.24(a), contains a list of contaminants and their associated maximum allowable concentrations. If a contaminant, such as selenium, exceeds its maximum allowable concentration, when tested using the Toxicity Characteristic Leaching Procedure (TCLP) analysis as specified at 40 C.F.R. Part 261 Appendix 2, then the material is classified as hazardous. The TCLP test uses a dilute acetic acid either in deionized water (TCLP fluid 2) or in deionized water with a sodium hydroxide buffer (TCLP fluid 1). Both extracts attempt to simulate the leachate character from a decomposing trash landfill in which the hazardous waste being tested for is assumed to be disposed of in and thus subject to the acetic acid leaching condition. Waste containing leachable selenium (Se) is currently classified as hazardous waste due to the toxicity characteristic, if the level of selenium extracted in a TCLP analysis is above 1.0 milligrams per liter (mg/L) or parts per millions (ppm). The TCLP test is designed to simulate a worst case leaching situation, that is leaching conditions which would typically be found in the interior of an actively degrading municipal landfill. Such landfills normally are slightly acidic with a pH of approximately 5±0.5.

Additionally, U.S. EPA land disposal restrictions prohibit the land disposal of solid wastes which leach in excess of maximum allowable concentrations upon performance of the TCLP analysis. The land disposal regulations require that hazardous wastes are treated until the heavy metals do not leach at UTS levels from the solid waste at levels above the maximum allowable concentrations prior to placement in a surface impoundment, waste pile, landfill or other land disposal unit as defined in 40 C.F.R. 260.10. The most recent LDR UTS levels for Se under 40 CFR 268.48 is 5.7 parts per million (ppm), higher than the TCLP generator criteria and thus less stringent.

Leach test conditions thus include the conditions to which an ash, waste, material or soil is subjected during dilute acetic acid leaching (TCLP), buffered citric acid leaching (STLC), distilled water, synthetic rainwater or carbonated water leaching (US SPLP, Japanese and Swiss and SW-924). Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached selenium is then analyzed by Inductively-Coupled Plasma (ICP) after filtration of a 100 ml aliquot from the tumbler through a 45 micron glass bead filter.

Of specific interest and concern regarding the present invention is the leaching of selenium under non-landfill conditions such as open industrial sites, waste storage cells, waste piles, waste monofills and under regulatory tests which attempt to simulate water leaching for determination of hazardousness of any given soil, material or waste.

The present invention provides a method of reducing the leachability of selenium under TCLP, SPLP, CALWET, rainwater and surface water leaching conditions as well as under regulatory water extraction test conditions as defined by waste control regulations in Japan, Switzerland, Germany, Sweden, The Netherlands and under American Nuclear Standards for sequential leaching of wastes by deionized water.

Unlike the present invention, prior art additives and mixtures have focused on reducing the leachability of non-selenium metals such as Lead, Arsenic, Cadmium, Chromium under TCLP and landfill leaching conditions.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb and Cd such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial waste water contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

Unlike the present invention, however, none of the prior art solutions were designed to allow specifically for stabilization of selenium bearing material or waste.

### SUMMARY OF THE NVENTION

The present invention discloses a selenium bearing material or waste stabilization method through contact of material or waste with water and stabilizing agents including phosphates, Portland cement, dolomitic lime, silicates and combinations thereof which are properly chosen to complement the material or waste constituency and desired material or waste handling characteristics. The selenium stabilizing agents proven effective are provided in both in dry and wet chemical form, and thus can be contacted with selenium bearing material either prior to waste production such as in-duct prior to air pollution control and ash collection devices or after waste production in material collection devices or waste piles. Water for hydration and inducement of reactivity between Selenium and stabilizing agents can be applied before, during or after stabilizer addition depending on the process limitations. For example, water addition for selenium bearing high lime or carbonate based scrubber residue would be after Air Pollution Control (APC) Units, thus avoiding caking of filter baghouse or Electrostatic Precipitating units, but before discharge to open dumpster containers . . . thus avoiding RCRA Part B permitting.

It is anticipated that the water and stabilizers can be used for both RCRA compliance actions such that generated wastes or materials from furnaces, incinerators and other facilities do not exceed the TCLP hazardous waste criteria of 1.0 ppm under TCLP or CERCLA (Superfund) response where stabilizers are added to waste piles or storage vessels previously generated. The preferred method of application of stabilizers would be in-line within the property and facility generating the selenium bearing material, and thus allowed under RCRA as a totally enclosed, in-tank or exempt method of TCLP stabilization without the need for a RCRA Part B hazardous waste treatment and storage facility permit.

### DETAILED DESCRIPTION

Environmental regulations throughout the world such as those promulgated by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a low exposure form, thus passing leach tests and allowing the wastes to be either reused on-site or disposed at local landfills without further and more expensive control means such as hazardous waste disposal landfills or facilities designed to provide metals stabilization. The primary focus of scientists has been on lead, cadmium, chromium, arsenic and mercury, as these were and continue to be the most significant mass of metals contamination in soils. Materials such as paints, and cleanup site wastes such as battery acids and slag wastes from smelters are major lead sources. Recently, however, there exists a demand for control methods of Selenium from air pollutions control scrubber ash residues and contaminated soils.

The present invention discloses a selenium bearing material or waste stabilization method through contact of material or waste with water and stabilizing agents including phosphates, Portland cement, silicates, quicklime and combinations thereof The selenium stabilizing agents found effective are available in dry, slurry and wet chemical form, and thus can be contacted with selenium bearing material prior to waste generation such as induct prior to air pollution control and ash collection devices or after waste production in collection devices such as hoppers, dump valves, conveyors, dumpsters or waste piles. Hydration was found to be important for Se control, possibly due to improved contact with stabilizers or benefits from heat of hydration reactions between water and Selenium bearing wastes such as lime and/or carbonate based scrubber residues.

It is anticipated that the stabilizers can be used for both RCRA compliance actions such that generated materials from furnaces, incinerators and other facilities do not exceed the TCLP hazardous waste criteria of 1.0 ppm under TCLP or CERCLA (Superfund) response where stabilizers are added to waste piles or storage vessels previously generated and now regulated under RCRA as a hazardous waste pre-disposal. The preferred method of application of stabilizers would be in-line within the property and facility generating the selenium bearing material, and thus allowed under RCRA as a totally enclosed, in-tank or exempt method of TCLP stabilization without the need for a RCRA Part B hazardous waste treatment and storage facility permit(s).

The use of Portland cement, silicates, quicklime, phosphates and combinations with phosphates including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof would, as an example, provide various amount of phosphate, cement, silicates, lime and or combination contact with selenium material or waste. In certain cases such as use of amber and green acid, such acids embody sulfuric acid, vanadium, iron, aluminum and other complexing agents which could also provide for a single-step formation of complexed selenium minerals. The water contact point, water amount, phosphate, cement, silicate, lime and combination type, size, dose rate, contact duration, and application means could be engineered for each type of selenium material or waste.

Although the exact selenium stabilization formation molecule(s) are unknown at this time, it is expected that when selenium comes into contact with water and stabilizing agent(s), low water and low acid soluble compound(s) begin to form such as a mineral phosphate, twinned mineral, or precipitate through substitution or surface bonding, which is less soluble than the selenium element or molecule originally in the material or waste. Specifically twinning of selenium into pyromorphite amorphous crystals most likely occurs by adding calcium phosphate(s) to the selenium material or waste at standard temperature and pressure. It also remains possible that modifications to temperature and pressure may accelerate of assist formation of selenium minerals, although such methods are not considered optimal for this application given the need to limit cost and provide for optional field based stabilizing operations that would be complicated by the need for pressure and temperature control devices and vessels.

In another method, selenium material or waste is contacted with water and at least one phosphate in the presence of a complexing agent selected to generate specific mineral on the selenium bearing material or waste. The complexing agent could include iron, aluminum, calcium, chlorides, sulfates, vanadium, and various other agents which provide for or assist in formation of selenium minerals. Use of phosphates in the presence of complex agents for mineral formations of lead bearing wastes is taught by U.S. Pat. No. 5,722,928 issued to Forrester.

Examples of suitable selenium stabilizing agents include, but are not limited to, Portland cement, phosphate fertilizers, phosphate rock, pulverized phosphate rock, calcium orthophosphates, monocalcium phosphate, dicalcium phosphate, tricalcium phosphate, trisodium phosphates, calcium oxide (quicklime), dolomitic quicklime, silicates, sodium silicates, potassium silicates, natural phosphates, phosphoric acids, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof The amounts of water and stabilizing agent used, according to the method of invention, depend on various factors including desired solubility reduction potential, desired mineral toxicity, and desired mineral formation relating to toxicological and site environmental control objectives. It has been found that an amount of water from 50% to 100% by weight of waste and certain stabilizing agents such as amber wet process phosphoric acid, equivalent to between about 5% and about 15% by weight of selenium material or waste is sufficient for initial TCLP stabilization to less than 1.0 ppm. However, the foregoing is not intended to preclude yet higher or lower usage of stabilizing agent or combinations if needed since it has been demonstrated that amounts greater than 15% by weight also work, but are more costly.

The examples below are merely illustrative of this invention and are not intended to limit it thereby in any way.

### EXAMPLE 1

In this example brick furnace scrubber residue, produced with a composite of sodium carbonate and hydrated quicklime as Ca(OH)2 used as stack gas scrubber media with collection of selenium in air pollution control devices, was stabilized with varying amounts of water and stabilizing agents including amber phosphoric acid (WAA), Portland cement type A/B, 50% sodium silicate solution (NSS) and less than #16 mesh pulverized dolomitic quicklime with 1 hour curing. Both stabilized and un-stabilized scrubber ashes were subsequently tested for TCLP Se. Samples were extracted according to TCLP procedure set forth in Federal Register, Vol. 55, No. 126, pp. 26985-26998 (Jun. 29, 199), which is hereby incorporated by reference. The retained leachate was digested prior to analysis by ICP.

TABLE 1

| Stabilizer Dose (%) | TCLP Se (ppm) |
|---|---|
| 0 H2O + 0 Stabilizer | 1.9 |
| 15 TSP pulverized + 0 H20 | 1.1 |
| 5 TSP pulverized + 10 H20 | 1.1 |
| 5 Amber + 10 H20 | 1.1 |
| 10 Cement + 10 Amber + 50 H20 | 0.72 |
| 15 Amber + 50 H20 | 0.81 |
| 10 Amber + 50 H20 | 0.65 |

The foregoing results in Table 1 readily established the operability of the present process to stabilize selenium thus reducing leachability and bioavailability. Given the effectiveness of the stabilizing agents in causing selenium to stabilize as presented in the Table 1, it is believed that an amount of 10% water and stabilizing agents equivalent to less than 5% by weight of selenium bearing material or waste should be effective. It is also apparent from the Table 1 results that certain stabilizing agents and water blends are more effective for stabilization.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of selenium bearing material or waste, comprising contacting selenium bearing material or waste with water and at least one stabilizing agent in an amount effective in reducing the leaching of selenium from the material or waste to a level no more than 1.0 ppm Se as determined in an EPA TCLP test, performed on the stabilized material or waste, as set forth in the Federal Register, vol. 55, no. 126, pp. 26985-26998 (Jun. 29, 1990).

2. The method of claim 1, wherein the selenium stabilizing agent is selected from the group consisting of phosphates, Portland cement, silicates, lime, phosphates and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 2, wherein the salts of phosphoric acid are alkali metal salts.

4. The method of claim 2, wherein the phosphate salt is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

5. The method of claim 2, wherein the phosphate and complexing agent as iron, calcium, chloride, or aluminum are supplied as one product including triple superphosphate, wet process phosphoric acid and combination fertilizer mixtures.

6. The method of claim 2, wherein the stabilizing complexing agents are selected from polymer, calcium chloride, sodium chloride, potassium chloride, vanadium, boron, iron, aluminum, sulfates, sulfides or combinations thereof.

7. The method of claim 1 wherein selenium bearing furnace ash or lime and/or carbonate based scrubber residue is contacted with at least one stabilizing agent in effective amount to reduce leaching to TCLP non-hazardous or desired levels prior to or during collection of such ash in air pollution control device hoppers or containers and contacted with water after pouultion control device.

8. The method of claim 1 wherein selenium bearing furnace ash or lime and/or carbonate based scrubber residue is contacted with water and at least one stabilizing agent in effective amount to reduce leaching to TCLP non-hazardous or desired levels after collection of such ash in air pollution control device hoppers or containers.
